(19) United States
(12) Patent Application Publication
(10) Pub. No.: US 2005/0138617 A1
(43) Pub. Date: Jun. 23, 2005

(54) Adaptive discovery and configuration of a user-selected input/output device

(76) Inventor: Lee G. Friedman, Alpharetta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/740,744

(22) Filed: Dec. 19, 2003

(51) Int. Cl. G06F 9/445; G06F 9/44; G06F 15/177

(52) U.S. Cl. 717/174; 717/173; 717/175; 713/1; 713/2

(57) ABSTRACT

Systems and methods for discovering and configuring an audio input device that is coupled to any one of several externally-accessible input ports of a PC, and, which in one embodiment, incorporates a device discovery system that polls the plurality of input ports to discover a valid connectivity of the audio input device to the PC by detecting a signal that is generated by the audio input device in response to a user providing an audible stimulus to the audio input device. This system may further incorporate discovering and configuring a video input device coupled to one of several of the same, or different, externally-accessible input ports of the PC. In this system, the device discovery system polls the plurality of input ports to discover a valid connectivity of the video input device to the PC by detecting a signal that is generated by the video input device in response to a user providing a visual stimulus to the video input device.

### TECHNICAL FIELD

The present disclosure is generally related to a personal computer (PC) and, more particularly, is related to input/output (I/O) devices connected to the PC.

### BACKGROUND

A typical PC has several input/output (I/O) devices, such as a keyboard, a mouse, a joystick and a microphone that are connected to it. Such connections are carried out using one or more externally-accessible connectors that are generally referred to as I/O ports of the PC. Examples of such PC ports include a printer port, a modem port, a keyboard port, a mouse port, a microphone port and a speaker port. Some of these ports are unique in their physical characteristics and are often recognizable by PC-savvy users. For example, a printer port comprises a parallel port connector having a large number of contact pins whereas a modem port, which is a serial connector, has relatively fewer contact pins. Similarly, a mouse port has a circular profile with a flat section on one side, thereby allowing a user to plug in the mouse cable only when its connector is oriented in a specific direction. On the other hand, an audio port on a sound card has a circular profile with a center conductor wherein an audio cable connector can be plugged into it regardless of connector orientation.

While such mechanical configurations reduce the possibility of erroneous connections, the nature and sheer numbers of such connections do not necessarily prove user-friendly to less-technical users. The advent of plug-and-play technology and the use of universal connectors such as those employed in the Universal Serial Bus (USB), have eased the burden on the part of users of determining an appropriate port to plug in an I/O device. Though such universal connectivity has provided several advantages, especially in a USB configuration, which allows as many as 127 peripheral devices to be plugged into a PC, several disadvantages have also been encountered.

For example, if two similar devices, such as two microphones, are plugged into a PC using two distinct ports, whether such ports are USB or non-USB, a user may encounter difficulties in determining which of the two microphones is the appropriate one to use when operating a particular software program that is running on the PC. This aspect can be explained further, using FIG. 1 as reference. PC 100, which is a typical desk-top PC, has a number of I/O devices connected into it, as shown. Drawing attention to audio input devices, microphone 105 is plugged into an audio port 106 located on sound card 110, while a second microphone 121 that is incorporated into camera assembly 120 is shown connected into USB connector 125. When an audio-video program, for example, Microsoft® NetMeeting® is to be installed on PC 100, a user recognizes relatively easily that the device for capturing video information will be camera assembly 120.

On the other hand, the associated audio input, which will be microphone 121 in camera assembly 120, may prove to be less easily recognizable because microphone 121 may appear to the user merely as a couple of tiny openings in the plastic housing of the camera assembly 120. Consequently, the user may erroneously assume that microphone 105, which is more readily visible, is the audio input device to be used. This can lead to frustration, especially among less-technical users, when the installation program does not receive an appropriate audio input and consequently responds by displaying a message advising the user to verify the microphone connection.

Furthermore, when multiple devices have been connected to PC 100, users may find it daunting to carry out troubleshooting using Microsoft's Control Panel to check whether a device conflict has occurred. If such a conflict is indeed indicated in the Device Manager menu of the Control Panel, in most cases it turns out to be extremely difficult for a user to rectify the situation without having a detailed understanding of PC technology.

As another example of difficulties encountered with I/O devices, let us assume that a voice recognition program was installed in PC 100 with microphone 105 connected into the audio input port of sound card 110. If microphone 105 was subsequently discarded and a newer microphone with a USB connector were to be used, a user may discover that merely plugging this new microphone into a USB connector does not automatically configure this microphone as the appropriate audio input device into the voice recognition program. In this example, PC 100 is expecting the audio input signal to be provided via the audio input port of sound card 110, and consequently ignores the USB microphone even though the microphone was correctly installed together with a suitable device driver, where applicable.

It is therefore desirable to provide solutions that address various shortcomings and difficulties faced by an average PC user.

### SUMMARY OF THE DISCLOSURE

One embodiment, among others, of the present disclosure is a device discovery system that identifies a user-desired input device among a number of substantially similar input devices that are connected to a PC. The identification is carried out by detecting a signal that is generated by the user-desired input device in response to a signal stimulus provided by a user.

A second embodiment includes discovering and configuring a user-desired input device among a number of substantially similar input devices connected to a PC. This embodiment includes using a software wizard to provide instructions to a user; instructing the user to provide a signal stimulus into the user-desired input device; measuring a first signal amplitude that is generated by a first input device among a number of substantially similar input devices; measuring a second signal amplitude that is generated by the user-desired input device in response to the signal stimulus provided by the user; and processing the first and second signal amplitudes to identify the user-desired input device.

Other systems, methods, and/or computer program products according to embodiments will be or become apparent to one skilled in the art upon review of the following drawings and detailed description. It is intended that all such additional systems, methods, and/or computer program products be included within this description, be within the scope of the present disclosure, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in drawings, like reference numerals designate corresponding parts throughout the several views.

FIG. 1 is a prior art illustration of a PC that includes several I/O devices that are connected to various ports of the PC. Some of these I/O devices are similar to each other in their construction and/or functionality.

FIG. 2 illustrates a PC that includes several I/O devices that are connected to various ports of the PC. Some of these I/O devices are similar to each other in their construction and/or functionality. The PC incorporates a system for discovery and configuration of a user-selected device.

FIG. 3 is a block diagram illustrating various functional blocks of one embodiment, among many, of the PC of FIG. 2.

FIG. 4 is a flow chart that illustrates one embodiment of a method of discovering and configuring a user-selected device, such devices including a video input device, an audio input device, and an audio output device.

FIGS. 5A and 5B show a flow chart that illustrates further details of a method of discovering and configuring the video input device of FIG. 4. This video input device is one of several video input devices connected to a PC.

FIGS. 6A and 6B show a flow chart that provides further details of a method of discovering and configuring the audio input device of FIG. 4. This audio input device is one of several audio input devices connected to a PC.

FIG. 7 shows a flow chart of a method of ambient noise measurement associated with the audio input device of FIG. 4.

FIG. 8 shows a flow chart of a method of configuring the sensitivity of the audio input device of FIG. 4.

FIG. 9 shows a flow chart that provides further details of a method of discovering and configuring the audio output device of FIG. 4. This audio output device is one of several audio output devices connected to a PC.

FIG. 10 shows an exemplary welcome screen of a software wizard that is used in the discovery and configuration system.

FIG. 11 shows one exemplary screen of a software wizard to discover and configure an audio input device. This audio input device is one of several audio input devices connected to a PC.

FIG. 12 shows one exemplary screen of a software wizard to discover and configure an audio output device. This audio output device is one of several audio output devices connected to a PC.

FIG. 13 shows one exemplary screen of a software wizard to discover and configure a video input device. This video input device is one of several video input devices connected to a PC.

### DETAILED DESCRIPTION

While the description below refers to certain exemplary embodiments, it is to be understood that the disclosure is not limited to these particular embodiments. On the contrary, the intent is to cover all alternatives, modifications and equivalents included within the spirit and scope of the disclosure as defined by the appended claims. Also, the terminology used herein is for the purpose of description and not of limitation.

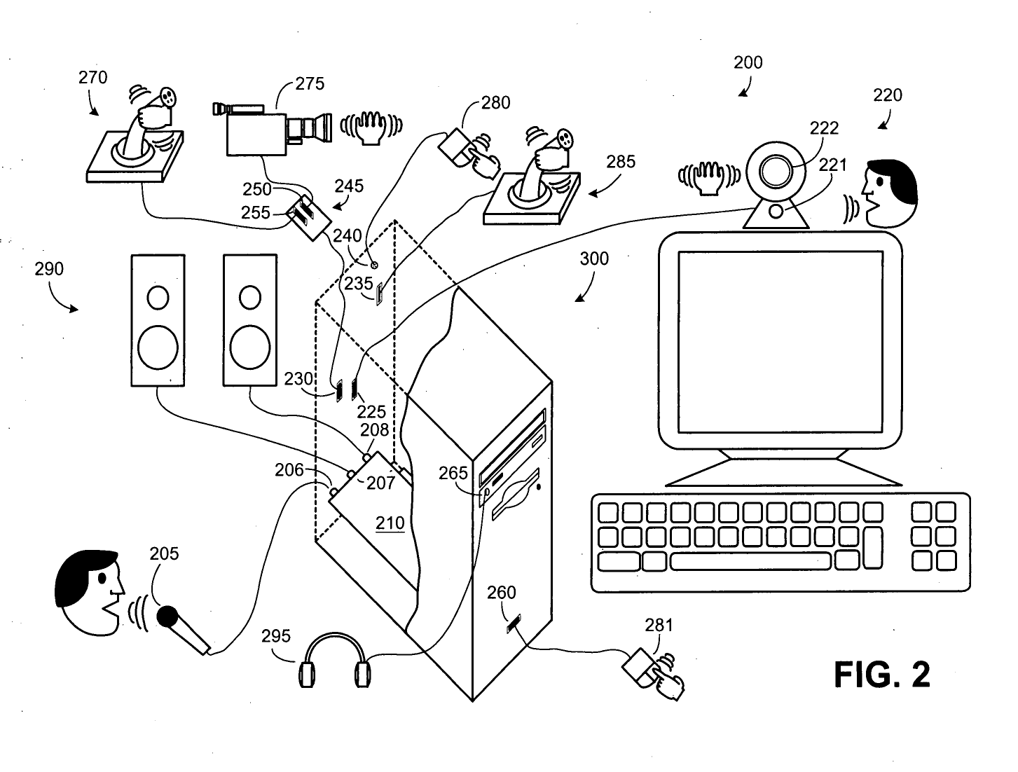

FIG. 2 illustrates one among many embodiments, of a PC system 200 comprising a PC 300 together with several input/output (I/O) devices that are communicatively coupled to PC 300. It will be understood that the term “coupled” as used here, encompasses wireline, wireless, and optical connectivity. PC 300 incorporates a discovery and configuration (D&C) system that is used for discovering and configuring a user-desired I/O device. The I/O devices of PC system 200 include some devices that are substantially similar to each other in hardware structure and/or in functionality.

As a first example of such similarity, mouse 280 that is plugged into mouse port 240 of PC 300, is substantially identical to mouse 281 that is plugged into USB port 260. When identical in hardware structure, both mouse 280 and mouse 281 comprises a 2-button roller-ball architecture, probably manufactured by the same manufacturer. Alternatively, mouse 280 comprises an optical mouse, while mouse 280 comprises a trackball mouse. It will be understood that the functionality and/or operational characteristics of the latter two devices are still identical even when the hardware has been implemented in alternative ways.

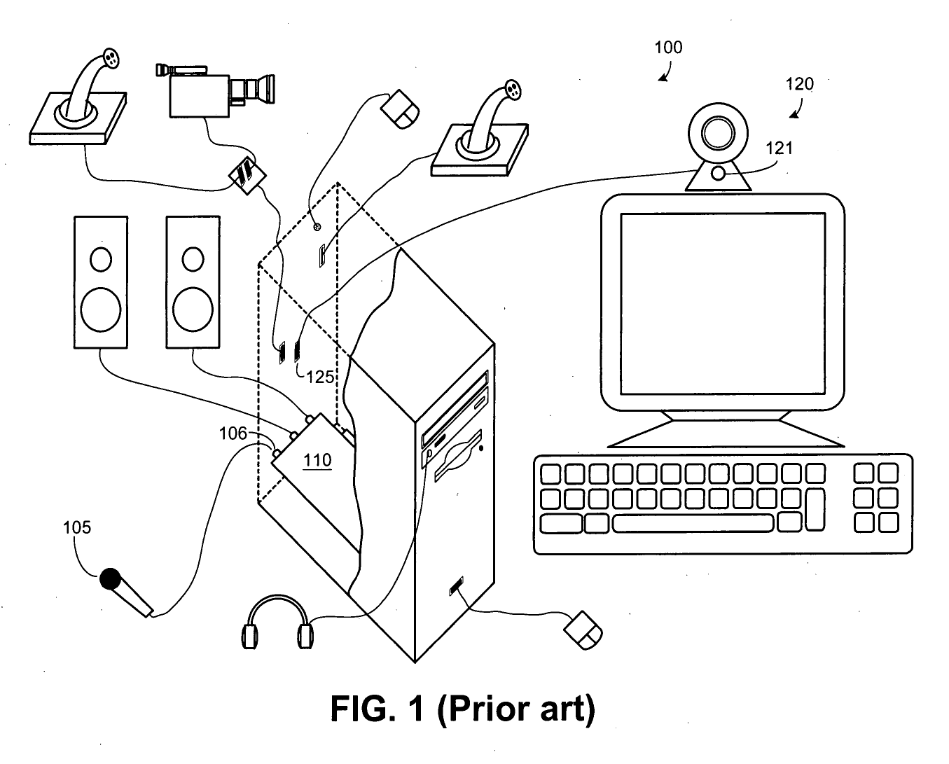

As a second example, a first joystick 285 is plugged into game port 235 while a second joystick 270 is plugged into USB port 255 located in USB hub 245. USB hub 245 is one example of a solution to increase the number of USB ports that can be serviced by PC 300. In FIG. 1, USB hub 245 connects into USB port 120 of PC 300 and permits two I/O devices (joystick 270 and video camera 275) to be connected into PC 300. Joysticks 285 and 270 are identical in construction and in operation, or are identical in operation while being constructed in alternative manner of hardware. As a third example, hand-held microphone 205 is shown plugged into PC 300 via an audio input port 206 of sound card 210, while built-in microphone 221 of camera assembly 220 connects into PC 300 via USB port 225. Sound card 210 additionally incorporates audio output ports 207 and 208 that provide connections to a pair of stereo speakers 290.

While stereo speakers 290 constitute audio output devices, headphones 295 also constitute substantially similar audio output devices. Headphones 295 are plugged into an audio output connector 265 that is part of a compact disc player housed in PC 300.

It will be understood that the above-mentioned examples provide a few among many such examples of substantially similar I/O devices. Persons of ordinary skill in the art will understand that there are many other I/O devices such as, but not limited to, printers, scanners, personal digital assistants (PDAs), modems (external and/or internal to PC 300), analog and digital tape players, and digital cameras, that may be coupled to PC 300.

Persons of ordinary skill in the art will understand that typically, when these devices are first installed, an initial set-up procedure, which can use a software wizard, is activated to assist a user in installing the I/O device to operate with PC 300. This initial set-up procedure typically includes the installation of I/O device driver software that in some cases can be already present in the operating system (OS) of the PC 300, or alternatively, in other cases may be loaded onto the PC 300 from external sources such as CDs, disks and websites. Persons of ordinary skill in the art will further recognize that subsequently installed software application programs can “associate/link” one or more of these I/O devices to the application program and use the device driver to facilitate I/O transfer of signals when the application program is running.

Drawing attention to FIG. 2, in addition to the I/O devices shown, a few examples of user-provided signal stimuli into the I/O devices are also shown. Signal stimuli include, but are not limited to, audible input signals such as speaking into a microphone, and visual input signals such as waving a hand in front of a camera. As a first example, a user is shown speaking into a first audio input device microphone 221. Alternatively, this user, or a second user, speaks into microphone 205, which is a second audio input device that is connected to PC 300.

The relevance of this audio stimulus will be explained using an example wherein an audio-video chat application program, such as the Microsoft® NetMeeting® program or an Instant Messaging video chat program, is activated to carry out a videoconferencing session. Let us assume that microphone 221 was linked to Microsoft® NetMeeting® when the application was initially installed on PC 300. Consequently, when this application is currently activated, the audio input into the program is expected from microphone 221. If the user erroneously speaks into microphone 205 instead, the audio signal would not ordinarily be available to Microsoft® NetMeeting®. When the user realizes that his, or her, audio transmission is defective, as a first alternative, he can reconfigure the Microsoft® NetMeeting® to recognize microphone 205 as the desired audio input device, rather than microphone 221. This may be done via Control Panel utilities.

Unfortunately, this solution is undesirable when the user is not particularly tech-savvy, or even if tech-savvy, desires a more user-friendly solution. In a desirable alternative solution, the user launches a D&C software wizard to help him select microphone 205 as the input device. This process, which will be explained in greater detail using other figures, comprises a message generated by the D&C software wizard, wherein the wizard prompts the user to speak into a microphone of his, or her, choosing. When the user speaks into microphone 205, the wizard implements a discovery procedure that examines one or more audio inputs from one or more audio input devices, and identifies the device currently in operation. In this example, the audio signal amplitude from microphone 205 is measurably higher than that from microphone 221. Consequently, the D&C system determines that the user desires to use microphone 205, and carries out a linking, by typically using the Windows registry, between microphone 205 and the Microsoft® NetMeeting® application. As is known to persons of ordinary skill in the art, the Windows registry is a set of data files used to help Windows control hardware, software, and the user's environment.

The D&C software wizard may also be used to provide discovery and configuration of a user-selected video input device. FIG. 2 illustrates two exemplary video devices—a video camera 222 that is part of camera assembly 220, and a video camera 275 that is plugged into USB port 250. In this example, a user may desire to use video camera 275 as the video input device into Microsoft® NetMeeting®. Presumably, microphone 205 was previously selected as the audio input device, hence the microphone built into video camera 275 is ignored when Microsoft® NetMeeting® is operational.

Discovery and configuration of the desired video camera 275 comprises launching the D&C software wizard that prompts the user to wave his, or her, hands in front of the desired camera. When this is done, the wizard detects video camera 275 via a discovery process that measures the video signal amplitudes of one or more signals that are generated by the various video input devices connected to PC 300. In this example, the video signal amplitude from video camera 275 will be the strongest signal because of the movement of the user's hand in front of camera 275. Once it is ascertained that the user desires to use camera 275, this camera 275 will be configured to operate in conjunction with Microsoft® NetMeeting®.

It will be understood that a similar process can be carried out for various I/O devices wherein the user causes an appropriate action, in the form of a signal stimulus, to indicate his, or her, preference of an I/O device. Some examples of such signal stimuli include, but are not limited to, operating a button of a mouse, moving a joystick, depressing a button of a scanner, and activating a modem.

In addition to discovering and configuring one or more input devices, the D&C system can be additionally used to discover and configure one or more output devices among the I/O devices connected to PC 300. While FIG. 2 shows two such devices—headphone 295 and pair of speakers 290, it will be apparent to persons of ordinary skill in the art that output devices include many other devices such as, but not limited to, printers, digital recording devices, modems, and video projectors.

In one exemplary embodiment among many, the user selects one of several output devices from a drop-down menu list displayed by the D&C software wizard, whereupon the D&C system transmits a sound signal or other appropriate signal to permit the user to verify proper selection and operation of the output device. One example of such a sound signal comprises an audio tone that is transmitted out of speakers 290. The D&C system additionally permits the user to set a desired volume level of an audio output device, via the D&C software wizard.

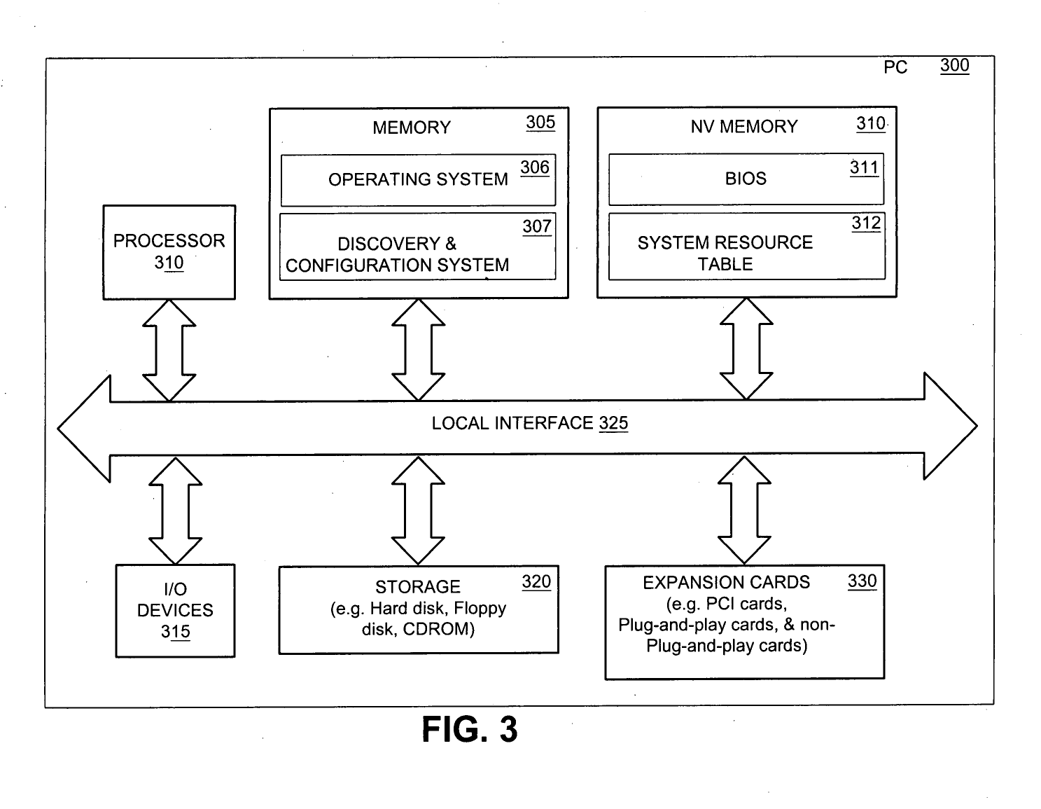

Various aspects and features of a D&C system to configure an audio device will be explained in further detail using other figures. Attention is now drawn to FIG. 3, which illustrates a PC 300 that incorporates one exemplary embodiment among many, of an adaptive D&C system 307. Generally, in terms of hardware architecture PC 300 includes a processor 310, memory 305, a non-volatile memory 310, a hard disk storage 320, one or more expansion devices 330, and one or more input and/or output (I/O) devices 315 (or peripherals) that are communicatively coupled via a local interface 325.

The local interface 325 can be, for example, but is not limited to, one or more buses or other wired or wireless connections, as is known in the art. The local interface 325 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 310 is a hardware device for executing software, particularly that stored in memory 305. The processor 310 can be any custom-made or commercially available processor, a central processing unit (CPU), an auxiliary processor among several processors associated with the PC, a semiconductor based microprocessor (in the form of a microchip or chip set), a macroprocessor, or generally any device for executing software instructions.

The memory 305 typically comprises volatile memory elements such as random access memory (RAM), for example, DRAM, SRAM, SDRAM, etc. The software in memory 305 may include one or more separate programs, each of which comprises an ordered listing of executable instructions for implementing logical functions. In the example of FIG. 3, the software in the memory 305 includes a D&C system 307 that is one among several embodiments of the present disclosure, and a suitable operating system (O/S) 306. A non-exhaustive list of examples of suitable commercially available operating systems 306 is as follows: (a) a Windows operating system available from Microsoft Corporation®; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; or (f) an appliance-based operating system, such as that implemented in handheld computers or personal data assistants (PDAs) (e.g., PalmOS available from Palm Computing, Inc., and Windows CE available from Microsoft Corporation®. The operating system 306 essentially controls the execution of other computer programs, such as the D&C system 307, and provides input-output control, file management, data management, and memory management.

The D&C system 307 can be implemented using logic incorporated in programs such as a source program, executable program (object code), script, or any other entity comprising a set of instructions to be performed. When a source program, the program needs to be translated via a compiler, assembler, interpreter, or the like, which may or may not be included within the memory 305, so as to operate properly in connection with the O/S 306. Furthermore, the D&C system 307 can be written as (a) an object oriented programming language, which has classes of data and methods, or (b) a procedure programming language, which has routines, subroutines, and/or functions, for example, but not limited to, C, C++, Pascal, Basic, Fortran, Cobol, Perl, Java, and ADA.

The I/O devices 315 can include input devices, for example, but not limited to, a mouse, a joystick, a keyboard, and audio/video input devices such as a camcorder, a microphone, a digital camera, etc. Furthermore, the I/O devices 315 also include output devices, for example, but not limited to, a speaker, a video projector, a scanner; a headphone, a video monitor, etc. Finally, the I/O devices 315 further include devices that communicate both inputs and outputs, for instance, but not limited to, a camcorder, a fax/printer/scanner device, a modulator/demodulator (modem) for accessing another device, system, or network, a radio frequency (RF) or other transceiver, a telephonic interface, a bridge, a router, etc.

Storage 320 comprises nonvolatile memory elements (e.g., hard drive, ROM, tape, CDROM, DVD, etc.) that are associated with operation of PC 300. Moreover, storage 320 incorporates electronic, magnetic, optical, and/or other types of storage media. Note that the storage 320 can have a distributed architecture, where various components are situated remote from one another, but can be accessed by the PC 300.

Non-volatile (NV) memory 310 contains a basic input output system (BIOS) 311 and a system resource table (SRT) 312. The BIOS 311 is a set of essential software routines that initialize and test hardware at startup, start the O/S 306, and support the transfer of data among the hardware devices. The BIOS 311 is stored in ROM so that the BIOS 311 can be executed when the PC 300 is powered up. The operation of BIOS 311 can be outlined by the following steps.

When PC 300 is powered up, processor 310 hands control over to BIOS 311, upon which a power-on self test is initiated. This test determines memory capacity and ensures that certain critical low-level hardware is operating correctly. Any errors are indicated by sequences of audible beeps. Once the test is completed, BIOS 311 disables all configurable devices related to PC 300.

BIOS 311 then identifies certain peripheral devices associated with PC 300, such devices including storage 320 and expansion cards 330. Plug-and-play cards are identified first, and a number is assigned to each of such cards. The cards are not enabled at this time. This is followed by BIOS 311 locating the primary boot or initial program load (IPL) device. This device is usually a storage device such as storage 320 that is a hard drive, a floppy drive, a CDROM, etc., that holds the operating system program. Secondary IPL devices are located after the primary IPL devices have been located. BIOS 311 then builds SRT 312, assigning conflict-free resources according to devices found by BIOS 311, as well as configuration data that can also be stored in NV memory 310.

This is followed by the selection and enabling of the primary input device (keyboard) and output device (monitor) of I/O devices 315, so that if trouble occurs during the boot process, BIOS 311 can display a recovery screen and allow the user to select a stored configuration of system settings that are known to work. This configuration is captured from a prior session when PC 300 had booted successfully, and the settings are stored in NV memory 310.

BIOS 311 then scans for non-plug-and-play devices as well as cards connected to the local interface 325, when this interface is a peripheral component interconnect (PCI) bus. Data from the ROMs in each of these devices is added to SRT 312. BIOS 311 also resolves any device conflicts and configures the chosen boot device, after which plug-and-play devices are enabled by interacting with option ROMs using appropriate parameters.

The bootstrap loader is then started and the IPL device loads the operating system from storage 320 into memory 305. After this has been completed, BIOS 311 hands over control to operating system 306, which then may perform further resource assignments.

The advent of the Microsoft® Windows 95® operating system popularized plug-and-play functionality, which not only simplified the job of adding expansion cards, but also helped to define a consistent mechanism to let BIOS 311 recognize and configure multiple devices connected to PC 300. Plug-and-play technology gives BIOS 311 the freedom to modify the interrupt number and I/O addresses that the disk controller (not shown) uses to avoid resource conflicts. USB and IEEE 1394 systems allow devices to be hot-plugged, and BIOS 311 stores system resource information in a dynamic manner for every device that has been plugged into PC 300. The dynamic manner of operation permits system resources such as interrupt number, address range, and device identity, to be re-assigned without requiring a reboot.

When PC 300 is in operation, the processor 310 is configured to execute software stored within the memory 305, to communicate data to and from the memory 305, and to generally control operations of the PC pursuant to the software. The D&C system 307 and the O/S 306, in whole or in part, but typically the latter, are read by the processor 310, perhaps buffered within the processor 310, and then executed.

D&C system 307 interacts with operating system 306 and/or SRT 312 to identify an I/O device that has been selected by the user, wherein in one embodiment, the selection is carried out via a user-action such as speaking, waving a hand, or activating an element of the I/O device. The identification process comprises a system that polls all the externally-accessible ports of the PC and measures signal amplitudes provided by the devices that are connected to one or more of such ports. A user-desired device may be found by detecting/measuring a signal that is measurably stronger than signals from other ports where the devices connected to these other ports have not been stimulated by the user. D&C system 307 may utilize data in SRT 312 for various purposes, such as for creating labels for enumerating a list of devices in a dropdown box of a software wizard. The software wizard guides a user in carrying out his, or her, selection of the I/O device of his, or her, choice. These features will be explained further using other figures.

When the D&C system 307 is implemented in software, as is shown in FIG. 3 hereafter, it should be noted that the D&C system 307 can be stored on any computer readable medium for use by or in connection with any computer related system or method. For example, the D&C system 307 can be detailed in a computer program or script that is stored and/or runs on a stand-alone PC, a stand-alone server, a network server, or on one or more computers that are part of a network.

In the context of this document, a computer readable medium is an electronic, magnetic, optical, or other physical device or means that can contain or store a computer program for use by or in connection with a computer related system or method. The D&C system 307 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example, but is not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

In an alternative embodiment, where the D&C system 307 is implemented using hardware logic, the D&C system 307 can be implemented with any or a combination of the following technologies, which are each well known in the art: a discrete logic circuit(s) having logic gates for implementing logic functions upon data signals, an application specific integrated circuit (ASIC) having appropriate combinatorial logic gates, a programmable gate array(s) (PGA), a field programmable gate array (FPGA), etc. The hardware can be housed in a stand-alone computer or in one or more computers of a network, and may further comprise hardware circuitry contained in a card that can be plugged into the local interface 325 of FIG. 3. Such hardware circuitry includes signal detection circuits that measure the signal strength of audio and/or video signals generated by I/O devices 315.

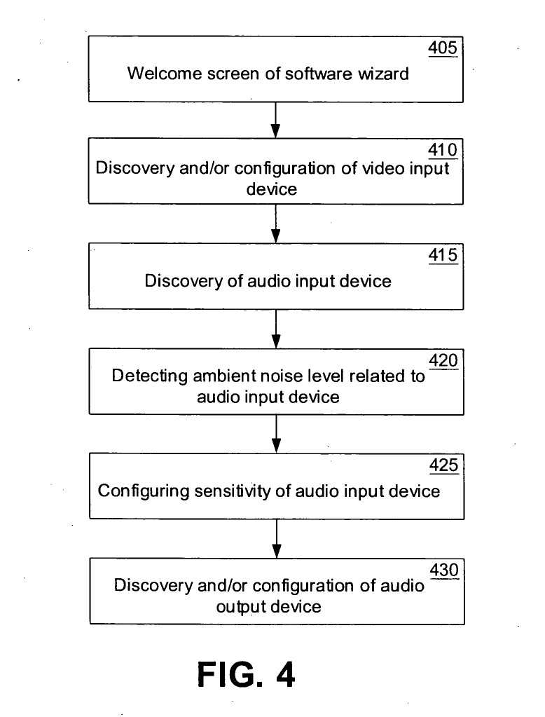

FIG. 4 is a flow chart of one of several exemplary methods of implementing a D&C system. It is to be understood that any process steps or blocks shown in FIG. 4, as well as in flowcharts of other figures, represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved. In some embodiments, certain blocks may be optionally omitted. For example, it may be desired merely to discover and configure audio devices, without implementing discovery and configuration of video devices. Code may also be contained in several devices of the disclosure, and may not be necessarily confined to any particular device. The explanation below, while possibly implying code residency and functionality in certain devices, does so solely for the purpose of explaining the concept behind the disclosure, and the description should not be construed as a limiting parameter for the disclosure's various implementations in other applications.

The exemplary method illustrated in FIG. 4 utilizes a software wizard that is launched by a user whenever the user desires to select one of several I/O devices that have been installed on a PC. This type of selection is typically triggered when an application program, such as Microsoft® NetMeeting®, is launched and the user discovers that this application does not recognize an I/O device that the user desires to use. While, in this example, the user launches the software wizard, in other embodiments, the launching of the software wizard can be triggered by various other factors. One example, among many, of such an alternative launch, is an automatic launch when the application program is started and the user attempts to use an I/O device that is not the default device for the application.

In block 405, a welcome screen of the software wizard provides information such as an introduction to the D&C system, directions for use, and other forms of user guidance. This is followed by discovery and configuration of various audio and video devices that constitute input and/or output media to a PC. In block 410, a user-selected video input device is discovered and configured. This process can be carried out by one or more wizard screens that prompt the user to, for example, wave his, or her, hand in front of the desired camera, and followed by a confirmation that the camera has been discovered by the D&C system. This confirmation can be implemented in the form of a window display inside the wizard screen, wherein the display shows the user waving his, or her, hand. Once the video input device has been discovered, it can be further configured for use with application programs such as Microsoft® NetMeeting® and/or other audio-video application programs.

In an alternative method of discovery and configuration of a video device, a wizard screen prompts the user to select a device of his, or her, choice, from a dropdown list that enumerates all the video devices that the D&C system has discovered currently connected to the PC. Once the user makes a selection from this list, the D&C system confirms the selection, for example, by displaying a video in a video window of the wizard screen.

In block 415, a user-selected audio input device is discovered and configured. This process is carried out by a series of wizard screens that prompts the user to speak into a desired microphone, discovers the microphone, and confirms discovery of the microphone. This is followed by optional steps wherein various parameters related to the selected microphone can be configured. Such steps include detecting an ambient noise level (block 420), setting, and/or detecting the sensitivity of the microphone (block 425), and voice recognition (not shown).

In block 430, a user-selected audio output device is discovered and configured. Multiple screens of the software wizard can again be utilized to prompt the user to select one of several audio output devices, such as speakers and headphones. In one embodiment among many, a list of all audio output devices that have been detected by the D&C system as currently connected to the PC, is displayed via a drop-down box of the wizard. Once the selection of an audio output device has been made by the user, wizard screens of the D&C system are further used to set audio output levels as desired by the user.

The flow chart of FIG. 4 not only provides for discovery and configuration of a user-selected device among multiple similar and/or dissimilar devices, but is also applicable to a user selection of a single device. For example, a user may plug in a single microphone into an audio input port of a PC, whether USB or non-USB, and utilize the D&C system to discover and configure the microphone. In such an embodiment, the D&C system scans multiple ports until the correct audio input port is discovered.

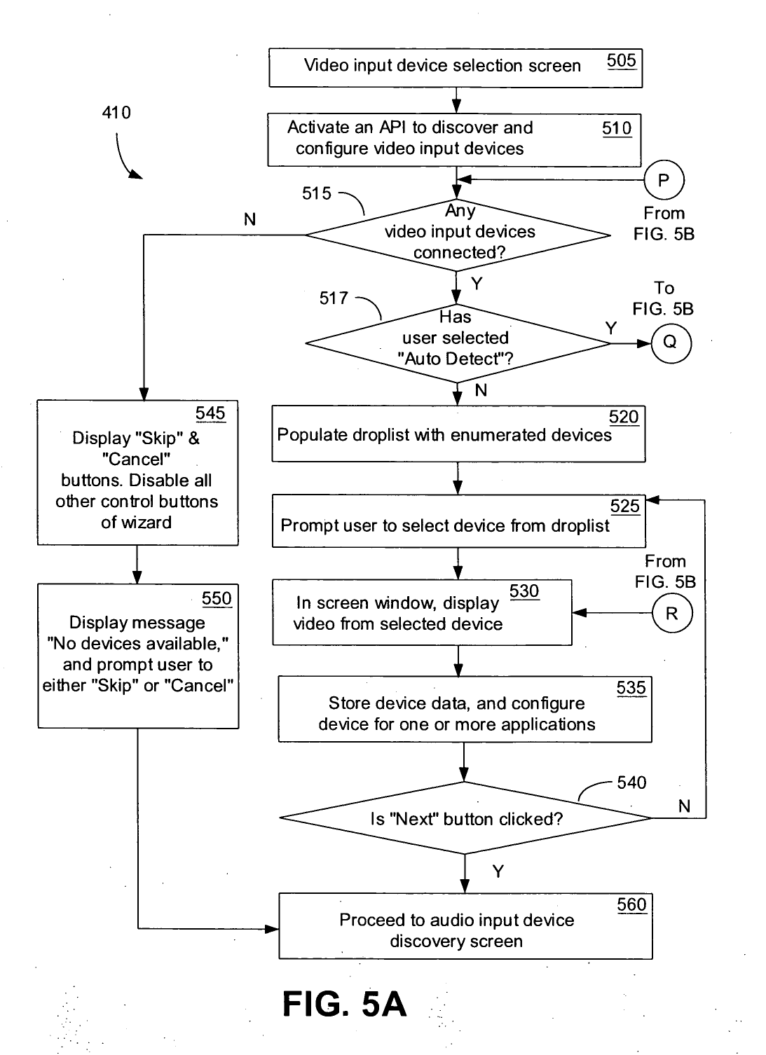

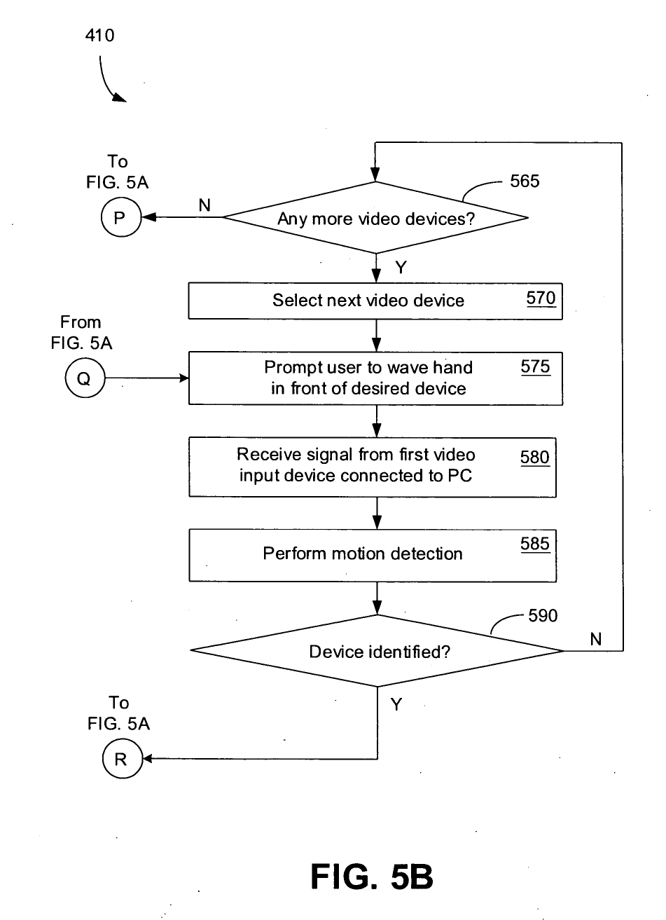

FIGS. 5A and 5B show a flow chart that provides further details of one of several exemplary methods to implement block 410 of FIG. 4. Drawing attention to block 505 of FIG. 5, a video device detection screen of the software wizard is displayed to the user. This screen includes a clickable icon, which the user can activate to initiate the detection of all the video input devices that are currently connected to the PC.

When such a detection has been initiated by the user in block 510, one or more application program interfaces (APIs) are activated. While several different software methods can be employed to implement block 510, one exemplary method includes the use of DirectX®, which comprises a set of APIs that enables programmers to write programs that access hardware features of a computer without knowing exactly what hardware is installed on the PC.

In block 515, a determination is made as to whether or not any video input devices are currently connected to the PC. If one or more video input devices are detected, the D&C system determines, in decision block 517, if the user has asserted an “Auto-detect” button of the wizard screen to begin an I/O device auto-detect process. If the Auto-detect button has not been asserted, in block 520, a drop down list of the wizard screen is populated to enumerate all the devices currently connected to the PC.

In block 525, the user is prompted to select one device from the dropdown list. When such a selection is carried out, a video signal that is generated by the selected video input device is displayed (block 530) in a video window of the wizard screen. The device ID of the selected video input device is then stored by the D&C system in block 535.

Block 540 is a decision block to verify whether the user has selected a video input device. If such a selection has not been made, the flowchart contains a loopback structure to block 525 that causes the D&C system to wait for a drop-list selection to be carried out.

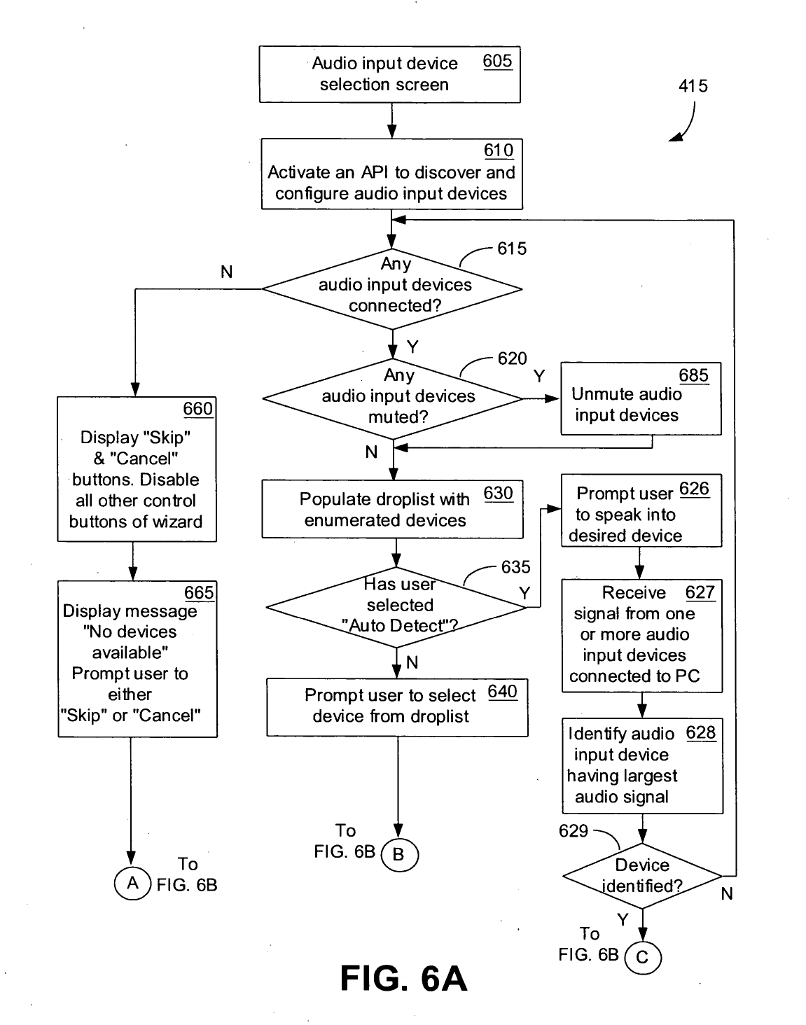

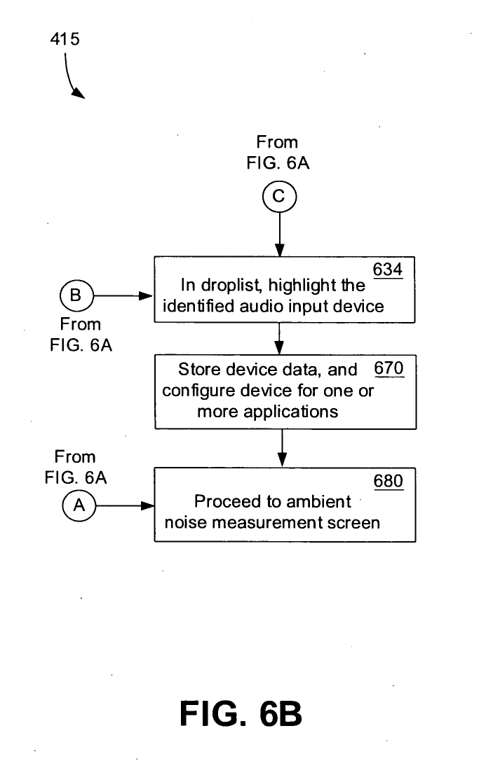

Drawing attention back to block 515, if the D&C system does not detect any video input devices connected to the PC, block 545 is activated to prompt the user to skip to the next screen of the wizard. This prompt can be accomplished via a message, as indicated in block 550. Block 560 links the flowchart of FIG. 5 to further blocks that are described in FIGS. 6A and 6B.

Attention is now drawn once again, to decision block 517. If the user has asserted the “Auto-detect” option, the D&C system implements block 575, where the user is prompted to wave his, or her, hand in front of the desired video input device. In block 580, the D&C system polls a first video input device that is connected to the PC, and carries out a motion detection (block 585) on any signal that may or may not be provided by the first video input device. It will be understood that no signal, or a signal of negligible amplitude, will be received from the first video input device if it is not the device into which the user is providing his, or her, hand-waving signal stimulus.

Numerous motion detection processes are known to persons of ordinary skill in the art, and in the interests of brevity, will not be explained in detail here. In one among many embodiments, the detection action of block 585 is primarily geared towards detecting large changes in pixel parameters. Among several factors indicative of such changes, edge variations, intensity changes, color changes, and pixel density variations are a few of many that can be used in the detection process. It will also be relevant to point out that in one embodiment among many, the detection process can be carried out using a threshold signal value. Such a process can be used when only a single video input device has been plugged into a user-preferred port of the PC. In an alternative embodiment, the detection process can be carried out in a comparative manner wherein the motion-related signal from the first video input device is compared against motion-related signals from one or more other devices.

If a video input device has not been identified in block 585, decision block 590 causes a loopback to decision block 565. In decision block 565, a determination is made if any more devices are connected to the PC. If more video devices are present, the next video device is selected (block 570), and blocks 575, 580, 585, and 590 are implemented. If no further video devices are indicated in decision block 565, a loopback to decision block 515 is carried out.

Drawing further attention to decision block 590, if a video input device has been identified, block 530 of FIG. 5A is implemented, followed by relevant blocks of FIG. 5A

FIGS. 6A and 6B illustrate a flow chart that provides further details to implement block 415 of FIG. 4. Drawing attention to block 605 of FIG. 6A, an audio device detection screen of the software wizard is displayed to the user. In this exemplary embodiment, this screen includes a clickable icon, which the user activates to initiate the D&C system to detect all the audio input devices that are connected to the PC.

If the icon has been clicked, in block 610, one or more application program interfaces (APIs) are activated. While several different software methods can be employed to implement block 610, one exemplary method includes the use of Direct X, which comprises a set of APIs that enables programmers to write programs that access hardware features of a computer without knowing exactly what hardware is installed on the PC.

In block 615, a determination is made by a discovery process of the D&C system whether any audio input devices are currently connected to the PC. If one or more audio input devices are detected, a determination is made in block 620 as to whether any of these devices have been muted. If none of the devices have been muted, block 630 is implemented to populate a drop down list in the screen of the wizard to enumerate all the audio input devices currently connected to the PC.

Block 635 is another decision block where a check is carried out to detect whether the user has clicked on an “auto detect” icon of the wizard screen. If this icon has not been clicked, block 640 permits the user to manually select an audio input device such as a microphone, from the drop down list. Once a device has been selected by the user from this list, the selected device is highlighted in the drop down box (block 634), followed by block 670, wherein a device ID of the selected device is stored in a suitable register of the PC. The device ID information can be additionally used to configure the selected device to operate together with one or more software applications.

Drawing attention back to block 615, if the D&C system does not detect any audio input devices connected to the PC, block 660 is activated to prompt the user to skip to the next screen of the wizard. This prompt can be accomplished via a message, as indicated in block 665. If, in block 620, a muted device was detected, the user is prompted to unmute all audio input devices (block 685).

Drawing attention back to block 635, if the user has clicked on the “auto detect” icon, the D&C system polls the input ports of the PC to detect all audio input devices that are currently coupled to the PC. In block 626, the user is prompted to begin speaking or tapping on the audio input device. The user is further instructed to continue speaking in a normal tone of voice until the system has recognized the user-desired device. When the user is speaking, the D&C system polls (block 627) one or more input ports of the PC to determine the audio signal amplitude of one or more audio devices that may be connected to this first input port. While the polling of one or more devices can be done in sequential fashion, it can also be carried out in parallel, where the PC obtains audio signals from multiple devices simultaneously, using a high-speed, sampling process, as is known in the art.

The polling process carried out on the various input ports encompasses polling and recording of the audio signal amplitude from the user-selected device. The recording process also identifies the particular port to which the user-selected audio device is connected. Because the user is speaking into the user-selected device, the audio signal amplitude from the port associated with the user-selected device will be measurably larger than the signal amplitudes from other ports whether these ports have devices connected to them or are unused ports. This measurement leads to the identification of the user-selected audio input device and the port information (block 632).

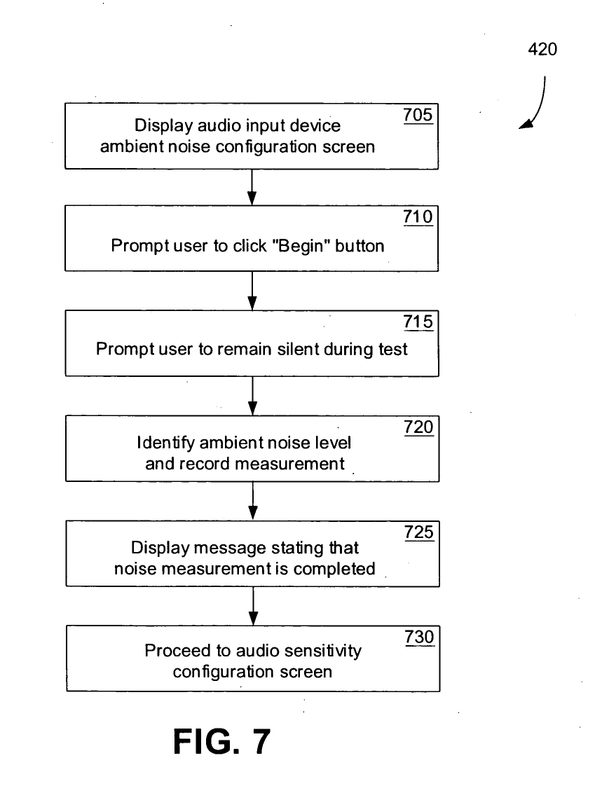

Once the identification is completed in block 632, the identifier label/enumerator of this device in the dropdown list of the wizard is then highlighted in block 634. In block 670, the D&C system stores the user preference for this device, and may further configure the selected device to operate together with one or more software applications. Block 680 links the flow chart of FIG. 6 to further blocks that are described in FIG. 7.

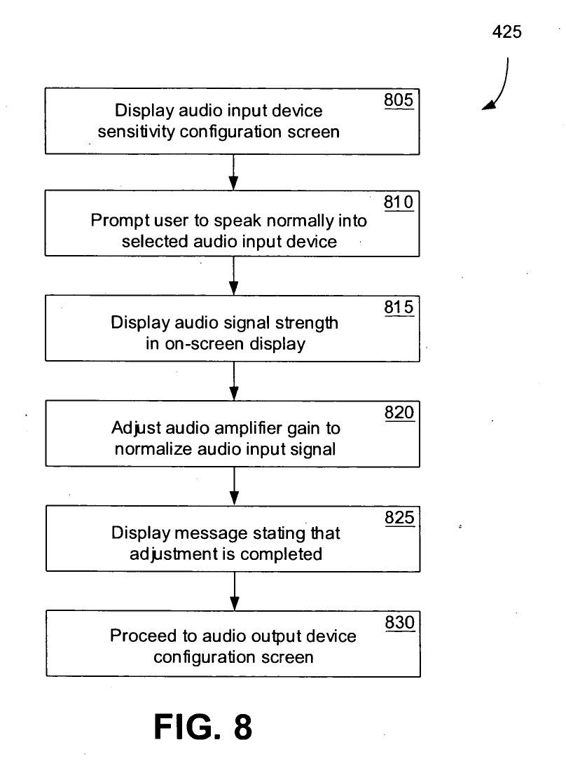

FIG. 7 illustrates a flow chart that provides further details to implement block 420 of FIG. 4. The user is prompted in block 710, to click on a “begin” button of the wizard when he is ready to carry out the ambient noise measurement and configuration process carried out by the D&C system. The user is further instructed (block 715) to remain silent while a measurement is carried out in block 720. Once the measurement has been completed and recorded, the user is informed that the process has been completed (block 725). Block 730 links the flow chart of FIG. 7 to further blocks that are described in FIG. 8.

FIG. 8 illustrates a flow chart that provides further details to implement block 425 of FIG. 4. In block 805, the wizard screen for audio sensitivity detection is displayed to the user. In block 810, the user is prompted to begin talking into the user-selected audio input device. The resulting signal strength is then displayed (block 815) on a real time level meter of the wizard, which may additionally comprise a slider volume control indicating the gain level. The prompt to the user may further include a message wherein the speaker is told to speak normally while the wizard displays signal strength and adjusts the gain and slider in a real time manner. This adjustment is done to normalize the audio, to allow for low pickup microphones, and to prevent users from overdriving the audio input device. After a period of time, the wizard alerts the user that the sensitivity level has been determined. This process uses block 820 wherein a decision is made whether the gain has to be changed. If such a change is required, the device gain is adjusted to provide the appropriate gain.

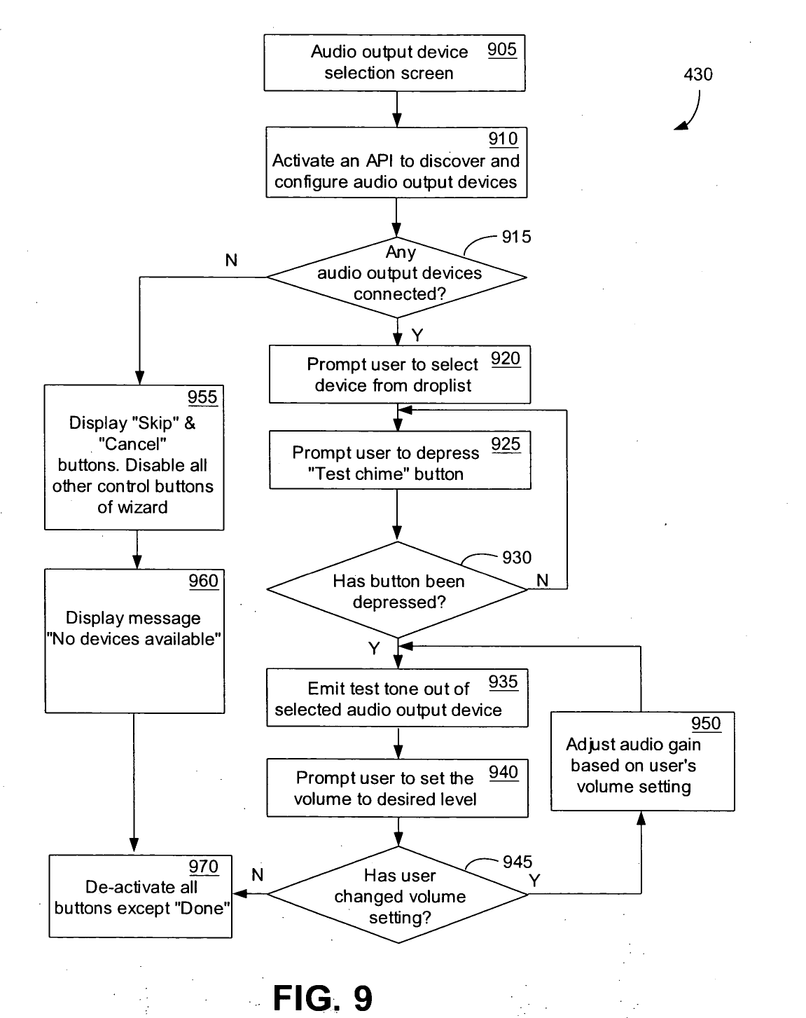

In block 825, a message is displayed to the user to indicate that the audio input device sensitivity adjustment has been completed. This is followed by block 830, which links the flow chart of FIG. 8 to further blocks that are described in FIG. 9.

FIG. 9 illustrates a flow chart that provides further details to implement block 430 of FIG. 4, wherein a user-selected audio output device is discovered and configured in block 905. In block 910, one or more application program interfaces (APIs) are activated, followed by block 915 where a determination is carried out whether any audio output devices have been coupled to the PC. The D&C system makes this determination, and if one or more such devices are present, the user is prompted in block 920 to select his preferred device from a drop down list displayed by the wizard.

The user is then prompted, in block 925, to press a “test chime” button. When this button is depressed, an audible test tone is transmitted by the D&C system, in block 935, through the user-selected audio output device. This is followed by block 940 where the user is prompted to set the volume of the audio output device to a desirable level. In one embodiment, this volume setting is carried out through a slider icon on the screen wizard. In decision block 945, the D&C system checks to determine if the user has changed the volume setting. If a change has been carried out, the D&C system appropriately adjusts, in block 950, the gain of the audio amplifier that drives the audio output device. If a change has not been carried out (as determined in decision block 945), all the buttons, except the “done” button, of the wizard screen are de-activated by suitable graying-out and other processes known in the art.

Drawing attention back to block 915, if the D&C system discovers that no audio output devices have been connected to the PC, in block 955, all buttons except the “skip” and “cancel” buttons of the wizard are inactivated, followed by block 960, where a message such as, “no devices available” is displayed on the screen. Block 960 is followed by block 970 where in one example, all buttons, except the “done” button of the wizard screen are de-activated by suitable graying-out and other processes known in the art.

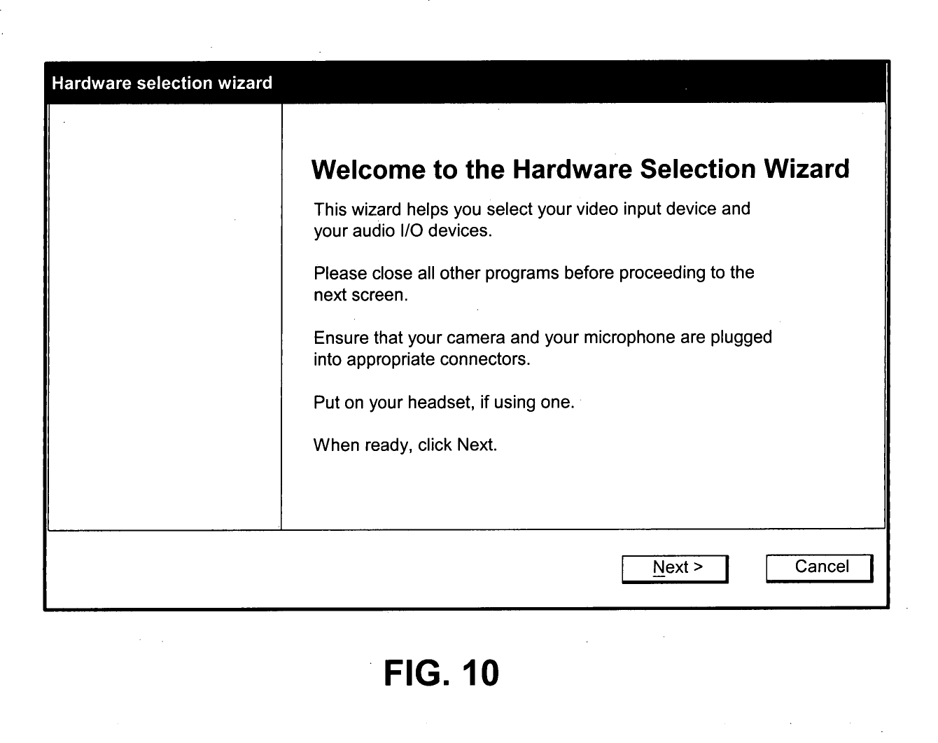

Attention is now drawn to FIG. 10, which illustrates a welcome screen of an exemplary embodiment of the software wizard that may be utilized by the D&C system. In this illustrated example, the screen prompts the user to connect the I/O devices into appropriate connectors. This instruction is provided so that the user connects input devices to input ports and output devices to output ports. Many PCs assist the user in carrying out this operation, by providing on their chassis, universally recognizable symbols for devices such as microphones, headphones, keyboards, etc.

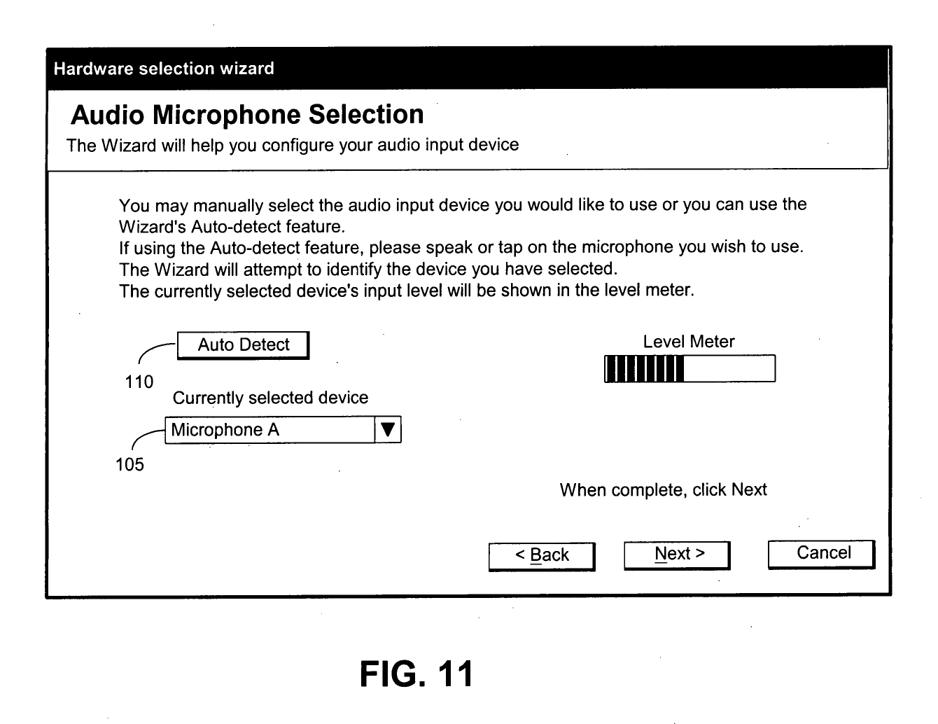

FIG. 11 shows an audio input device selection screen of the software wizard. In this example, the user may opt for a manual selection process or an automated selection process to discover and configure an audio input device. The manual selection process may utilize a drop down list 105 that displays all the audio input devices installed on the PC. In the auto detection process, the user is prompted to talk into a microphone of his, or her, choice, after activating an ‘auto detect’ button 110 of the wizard screen, and the D&C system discovers the correct device. The discovery may then be followed by other screens (not shown) that may be used for audio gain setting and for measuring ambient noise levels.

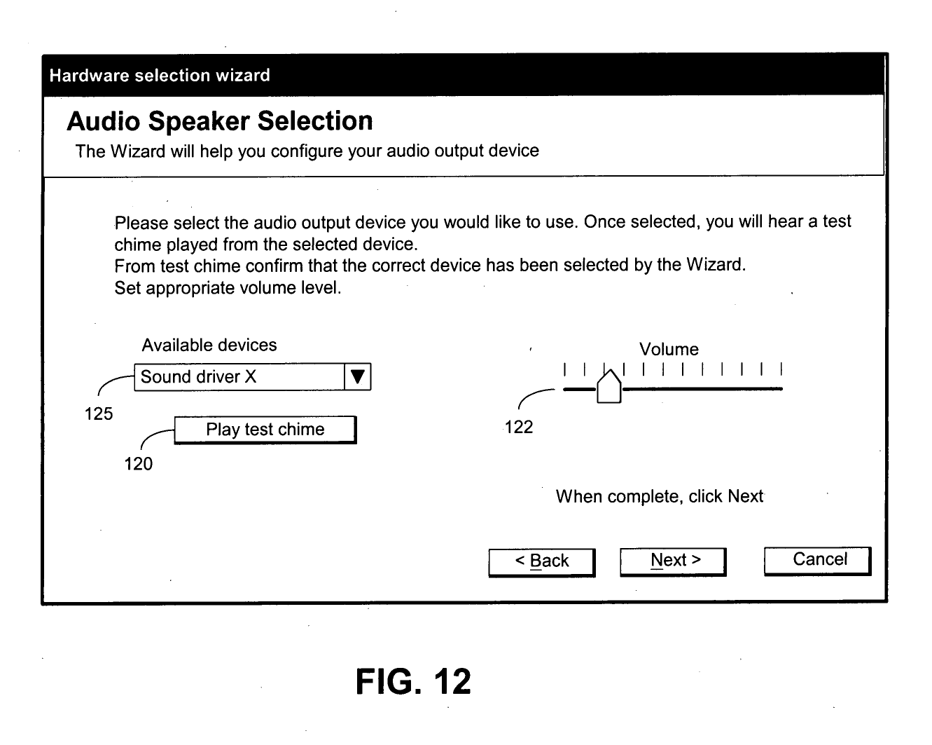

FIG. 12 shows an audio output device selection screen of the software wizard. In this example, the user is prompted to select a device from a drop-down list 125 of installed devices. After this selection is carried out, the user may play a test chime 120 or other audio tones, to allow setting an appropriate volume. The volume setting may be carried out by a slider control 122 that is displayed in the wizard screen.

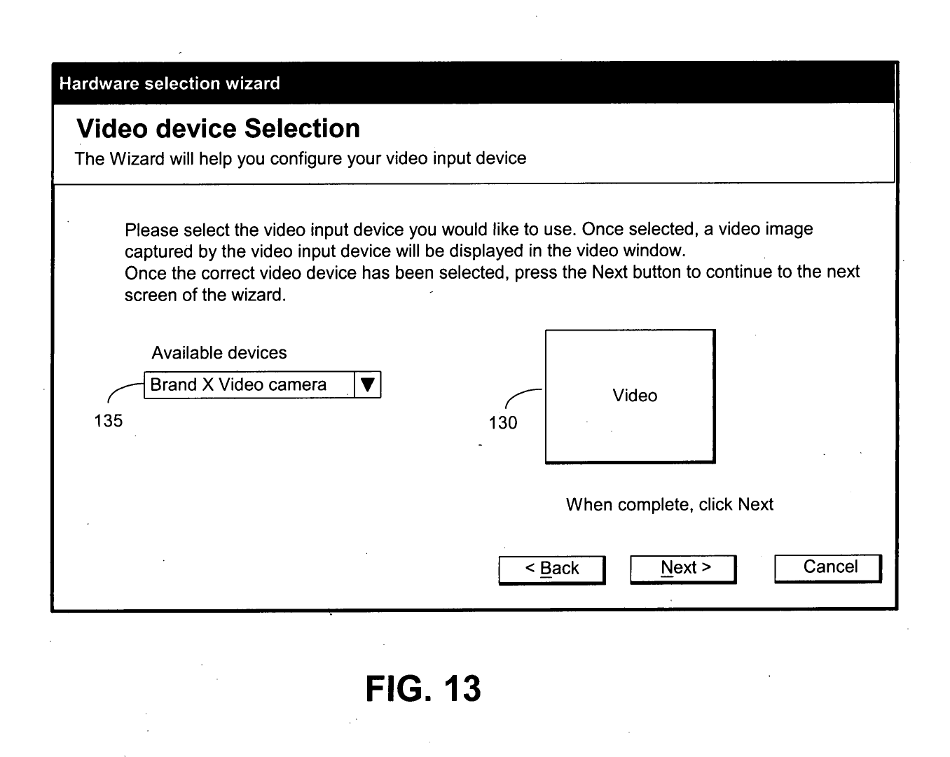

FIG. 13 shows a video input device selection screen of the software wizard. In this example, the user is prompted to select a video device from a drop down list 135. When a selection is carried out, a video image may be displayed in window 130. The video image may be a live video signal from a video camera, or may, alternatively, be a video image from a digital camera. It will be understood that many variations of this wizard screen may be implemented as appropriate for various video input devices. Such variations can also include an auto detect process wherein the user is prompted to wave his, or her, hand in front of the desired video device. When this action is carried out, the D&C system carries out a discovery process to identify this video device among several devices that may be currently connected to the PC. Once discovery is carried out, further actions related to configuration may be implemented. Such actions include adjusting video device settings, linking the video device to one or more software application programs, and controlling camera movements.

It should be emphasized that the above-described embodiments of the present disclosure are merely possible examples of implementations and are set forth merely for providing a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1. A PC system comprising:
a plurality of substantially similar input devices coupled to a respective plurality of externally-accessible input ports of a PC; and
a device discovery system that identifies a user-desired input device among the plurality of substantially similar input devices, wherein the identification is carried out by detecting a signal that is generated by the user-desired input device in response to a signal stimulus provided by a user.

2. The PC system of claim 1, further comprising a device configuration system that configures the user-desired input device to operate together with a software application program on the PC.

3. The PC system of claim 2, wherein the software application program is an audio-video communication program that permits the user of the PC to communicate with a second user of a second PC, via an audio-video communication link.

4. The PC system of claim 3, wherein the software program is a video chat program.

5. The PC system of claim 3, wherein the audio-video communication link comprises a digital subscriber line.

6. The PC system of claim 1, wherein the plurality of substantially similar input devices comprises audio input devices, and identifying the user-desired input device comprises the device discovery system unmuting the user-desired input device.

7. The PC system of claim 1, further comprising an output device that is housed together with the user-desired input device in a common enclosure.

8. A PC system comprising:
an audio input device coupled to any one of a plurality of externally-accessible input ports of a PC; and
a device discovery system that polls the plurality of input ports to discover a valid connectivity of the audio input device to the PC by detecting a signal that is generated by the audio input device in response to a user providing an audible stimulus to the audio input device.

9. The PC system of claim 8, further comprising a video input device coupled to any second one of a plurality of externally-accessible input ports of a PC; and wherein the device discovery system polls the plurality of input ports to discover a valid connectivity of the video input device to the PC by detecting a signal that is generated by the video input device in response to a user providing a visual stimulus to the video input device.

10. The PC system of claim 9, wherein the device discovery system unmutes the audio input device to discover the valid connectivity of the audio input device to the PC.

11. A software wizard program stored on a computer-readable medium, the program comprising:
logic configured to provide instructions to a user for selecting an audio input device from a plurality of substantially similar audio input devices that have been communicatively coupled to a first respective plurality of externally-accessible input ports of a PC; and
logic configured to identify the user-selected audio input device by detecting a signal that is generated by the user-selected audio input in response to an audible stimulus that is provided by the user to the user-selected audio input device.

12. The software wizard system of claim 11, further comprising:
logic configured to provide instructions to a user for selecting a video input device from a plurality of substantially similar video input devices that have been communicatively coupled to a second respective plurality of externally-accessible input ports of the PC;
logic configured to provide a dropdown list showing device identification labels for each of the plurality of video input devices; and
logic configured to provide instructions to the user in selecting a video input device from the dropdown list.

13. The software wizard system of claim 12, further comprising:
logic configured to identify the user-selected video input device by detecting a signal that is generated by the user-selected video input in response to a visual stimulus signal that is provided by the user to the user-selected video input device.

14. The software wizard of claim 13, further comprising:
logic configured to provide instructions to the user for selecting an audio output device from a plurality of audio output devices that have been communicatively coupled to a first respective plurality of externally-accessible output ports of a PC;
logic configured to provide a dropdown list showing device identification labels for each of the plurality of audio output devices;
logic configured to provide instructions to the user in selecting the audio output device from the dropdown list; and
logic configured to generate an audible test tone from the selected audio output device.

15. The software wizard of claim 14, further comprising:
logic configured to provide a volume control icon;
logic configured to provide instructions to the user to operate the volume control icon to set a desired volume of the selected audio output device; and
logic configured to generate an audible test tone corresponding to the desired volume, from the selected audio output device.

16. The software wizard of claim 12, wherein the first and second respective plurality of eternally-accessible input ports are respectively common ports.

17. A PC system comprising:
logic configured to discover a user-desired input device among a plurality of substantially similar input devices coupled to a respective plurality of externally-accessible input ports of a PC, wherein the discovery is carried out by detecting a signal that is generated by the user-desired input device in response to a signal stimulus provided by a user.

18. The PC system of claim 17, further comprising:
logic configured to link the software driver of the user-desired input device to a software application program on the PC.

19. The PC system of claim 18 wherein the software program is a video chat program.

20. A method of discovering and configuring a user-desired input device among a plurality of substantially similar input devices coupled to a respective plurality of eternally-accessible input ports of a PC, the method comprising:
launching a software wizard to provide instructions to a user;
instructing the user to provide a signal stimulus into the user-desired input device;
measuring a first signal amplitude that is generated by a first input device among the plurality of substantially similar input devices;
measuring a second signal amplitude that is generated by the user-desired input device in response to the signal stimulus provided by the user; and
processing the first and second signal amplitudes to identify the user-desired input device.

21. The method of claim 20, wherein the user-desired input device is an user-desired audio input device, and the signal stimulus is an audible signal that is coupled into the user-desired audio input device.

22. The method of claim 20, wherein the user-desired input device is an user-desired video input device, and the signal stimulus is a visual signal that is coupled into the user-desired audio input device.

23. A method of discovering and configuring a user-desired audio output device among a plurality of substantially similar output devices coupled to a respective plurality of externally-accessible output ports of a PC, the method comprising:
launching a software wizard to provide instructions to a user;
instructing the user to select the user-desired audio output device from a dropdown list of the software wizard showing device identification labels for each of the plurality of audio output devices; and
instructing the user to operate a volume control icon of the software wizard to set a desired volume of the user-desired audio output device; and
generating an audible test tone corresponding to the desired volume, from the user-desired audio output device.
